(19) United States
(12) Patent Application Publication
(10) Pub. No.: US 2015/0033616 A1
(43) Pub. Date: Feb. 5, 2015

(54) Rodent Poison Dispenser

(71) Applicant: Dillawer Anwar Kazzaz, San Rafael, CA (US)

(72) Inventor: Dillawer Anwar Kazzaz, San Rafael, CA (US)

(21) Appl. No.: 13/956,936

(22) Filed: Aug. 1, 2013

(51) Int. Cl. A01M 25/00

(52) U.S. Cl. CPC A01M 25/006
USPC 43/124

(57) ABSTRACT

A tool to pierce burrowing rodent infested grounds to find their tunnels and deposit poison therein.

### CROSS REFERENCE

Provisional patent application No.: 61/680,643—Filing Date: Aug. 7, 2012—Confirmation No. 9889

The invention is NOT made by an agency of the United States Government or under contract with an agency of the United States Government

Applicant DOES qualify for micro entity status under 37 CFR 1.27

### BACKGROUND OF THE INVENTION

Controlling burrowing rodents is a serious problem for farmers and homeowners alike. Rodents inflict damage on vegetation and crops causing substantial losses both in time and in resources. Rodent control is thus a necessary part of fruitful farming and gardening.

Over the years, many methods were devised to control burrowing rodents. Approaches to rodent control include either terminating or repelling them. Basic methods of terminating rodents are drowning by flooding their burrows, suffocating with poisonous gases, and killing them by placing poison or traps in their tunnels, among others. Repelling rodents is done by placing dog and cat hair, pepper products, and electric noise makers in their burrows. Where allowed, killing gophers by placing poison in their tunnels is the most conclusive method. But placing the poison is a laborious process, if at all successful, when done manually. To address this problem, poison-dispensing tools have been invented, but improvement to these tools is necessary, and is thus the subject of my invention.

Tools currently available to dispense poison in rodent tunnels are laborious to use and often not effective. There are two types of tools. The first consists of a stiff tubular shaft fitted at the bottom with a pointed fixed tip, and at the top with a poison reservoir open to the tube. The tube has a small outlet window above the tip that is operated by a lever at the top. To use this tool, one pierces the ground with the pointed tip to locate a rodent's tunnel; once in the tunnel, the lever is actuated to open the outlet window, allowing a dose of poison to flow into the tunnel. The shortcoming of this tool is the size and location of the outlet window. Restricted by design, the outlet window is too small and also recessed from the surface of the tube, often becoming clogged with soil. Additionally, the deposit of a dose of poison in the rodent's tunnel cannot be confirmed because the poison is dispensed from a large reservoir that is hard to gauge. The second tool used to dispense poison consists of a flexible shaft and a concentric cable within, fitted at one end with a cylindrical poison canister and on the other with a control knob. The poison canister has a lid that is attached to the cable within the flexible shaft and controlled by the knob at the other end. To use this tool, one locates and exposes a rodent's tunnel, inserts and pushes the poison-filled end of the tool in as far as the length allows, then pushes the knob to open the canister lid and deposit the poison. The tool is then pulled out and the tunnel is reconstructed carefully. This tool is laborious to use and not reliable; digging to locate a tunnel, uncovering it carefully to preserve it, pushing the tool into the tunnel, depositing the poison, pulling out the tool and finally rebuilding the tunnel leaving no detectable scent is a time consuming effort. Furthermore, pushing the poison canister a distance into the tunnel will push a soil pile ahead of it, so when the lid is opened to deposit the poison and the tool is removed, the pile of soil will either dam the tunnel or fall and cover the poison.

### SUMMARY OF THE INVENTION

My invention, Rodent Poison Dispenser (hereinafter referred to as ‘the tool’) is a time saving, reliable, and easy to use tool designed to locate rodents' tunnels and dispense poison therein, in order to control the damage done to vegetation and landscaping. My tool solves shortcomings associated with currently available tools made for the same purpose.

The tool consists of a steel tube containing a central steel rod. The central steel rod is attached at one end to a pointed steel tip and at the other end to a control knob. The pointed steel tip is a cap of the lower end of the steel tube, and also a poison compartment cover. The control knob, along with a compression spring and a locking tab, control the movements of the steel rod and hence the position of the pointed steel tip. A single-dose poison compartment is located within the lower end of the tube. The steel tube is fitted on the outside with a sliding filling funnel to facilitate loading the poison.

To load the tool with poison, hold it vertically by the steel tube, with the control knob pressed down against a flat surface. Slide the filling funnel up to the end of the tube and unlock the movement of the central steel rod by pressing down on the locking tab to open the poison compartment. Fill the poison compartment with one dose of granular poison using the filling funnel. Lift the tool up from the flat surface to release the control knob and allow the compression spring to force the poison compartment into the locked position. Lastly, return the filling funnel to its original position.

To use the tool, force the pointed steel tip into the ground where rodent tunnels are expected; when initial resistance to ground penetration is suddenly lost and felt again a tunnel is found, and the poison compartment will be within the tunnel. Especially when the ground is hard, a small diameter steel rod can be used to poke the soil and facilitate locating tunnels. Once in the tunnel, press down and keep one hand on the control knob, then release the locking tab while lifting the steel tube up against the control knob with the other. This will open the poison compartment and let the poison out into the tunnel. While still holding the control knob, push the steel tube back down to close the poison compartment. Pull the tool out and cap the hole made.

Advantages of my tool over other similar tools are as follows. First, with my tool the poison compartment opens wide, releasing poison out of the full circumference of the steel tube, unlike other tools where poison flow is restricted to a recessed and often clogged small side window on the circumference of the steel tube. Second, my tool is a single dose tool, allowing the user to confirm after each application that a dose of poison has been deposited, unlike tools that have a poison reservoir that makes it hard to confirm how much of the poison was deposited, if any. Third, my tool can be used at any point of the burrow with quick and easy access and exit, unlike tools that require digging and tunnel reconstruction.

### BRIEF DESCRIPTION OF THE DRAWINGS

FIG. 1: Upright Perspective of Rodent Poison Dispenser in ready state.

FIG. 2: Enlarged perspective of the Rodent Poison Dispenser control knob and locking mechanism in a locked state.

FIG. 3: Enlarged section of the Rodent Poison Dispenser's pointed steel tip and poison compartment.

FIG. 4: Perspective of Rodent Poison Dispenser at poison loading state.

FIG. 5: Perspective of Rodent Poison Dispenser at poison dispensing state.

FIG. 6: Enlarged perspective of the Rodent Poison Dispenser control knob and locking mechanism at poison dispensing state.

FIG. 7: Enlarged perspective of the Rodent Poison Dispenser pointed steel tip at poison dispensing state.

### REFERENCED EMBODIMENT

10 Control Knob.

11 Compression Spring.

12 Steel Rod.

13 Locking Tab.

14 Steel Tube Cap.

15 Plastic Filling Funnel.

16 Filling Funnel Stem.

17 Filling Funnel Stem Neck.

18 Filling Funnel Stern End.

19 Filling Funnel Stem Split.

20 Steel Tube

21 Pointed Steel Tip

22 Poison Retention Disk.

23 Poison Compartment.

24 Granular Poison (not claimed).

### DETAILED DESCRIPTION OF THE PREFERRED EMBODIMENT

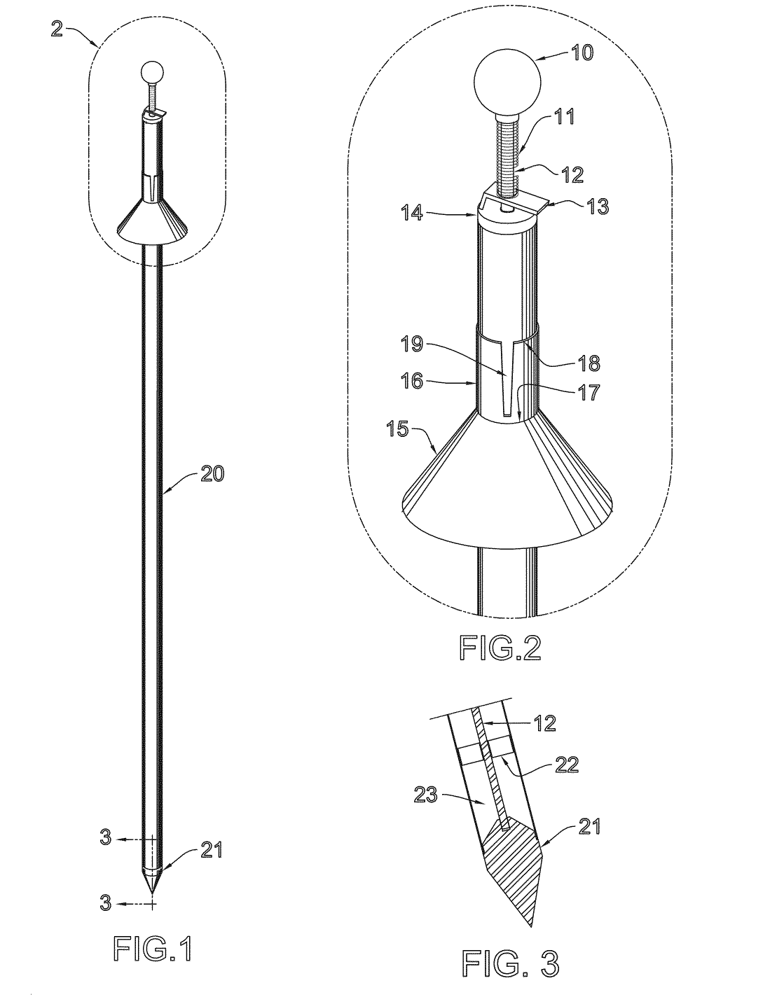

Now with reference to FIG. 1, in which there is illustrated the Rodent Poison Dispenser (hereinafter referred to as ‘the tool’) in upright position, a tool I have invented to locate rodent tunnels and dispense poison therein, in order to control damage rodents do to vegetation and landscaping. The tool consists of a steel tube 20 containing a steel rod 12. The lower end of the steel rod 12 is connected to a pointed steel tip 21 that caps the bottom end of the steel tube 20. The upper end of the steel rod 12 is connected to a control knob 10 to control its movements, and extends out of the top of the steel tube 20, sliding through the center of a steel tube cap 14. A locking tab 13 and a compression spring 11 slide on the steel rod 12 to lock and release its movements as needed. A poison retention disk 22 is firmly attached to the steel rod 12, which together slide inside the steel tube 20. A poison compartment 23, inside the lower end of the steel tube 20, is located between the poison retention disk 22 and the pointed steel tip 21. The poison compartment 23 is normally locked by the compression spring 11, which lifts the steel rod 12 by the control knob 10 and jams the locking tab 13 on the steel rod 12 to lock its movement. A plastic filling funnel 15 slips over and stays on the outside wall of the steel tube 20. A filling funnel stem 16 has an inside diameter at a filling funnel stem neck 17 equal to the outside diameter of the steel tube 20, and a slightly smaller inside diameter at a filling funnel stem end 18. On exact opposite sides of the filling funnel stem 16 are two filling funnel stem slit 19. The two filling funnel stem slit 19 allow the filling funnel stem 16 to slip over and hold the plastic filling funnel 15 anywhere on the outside wall of the steel tube 20.

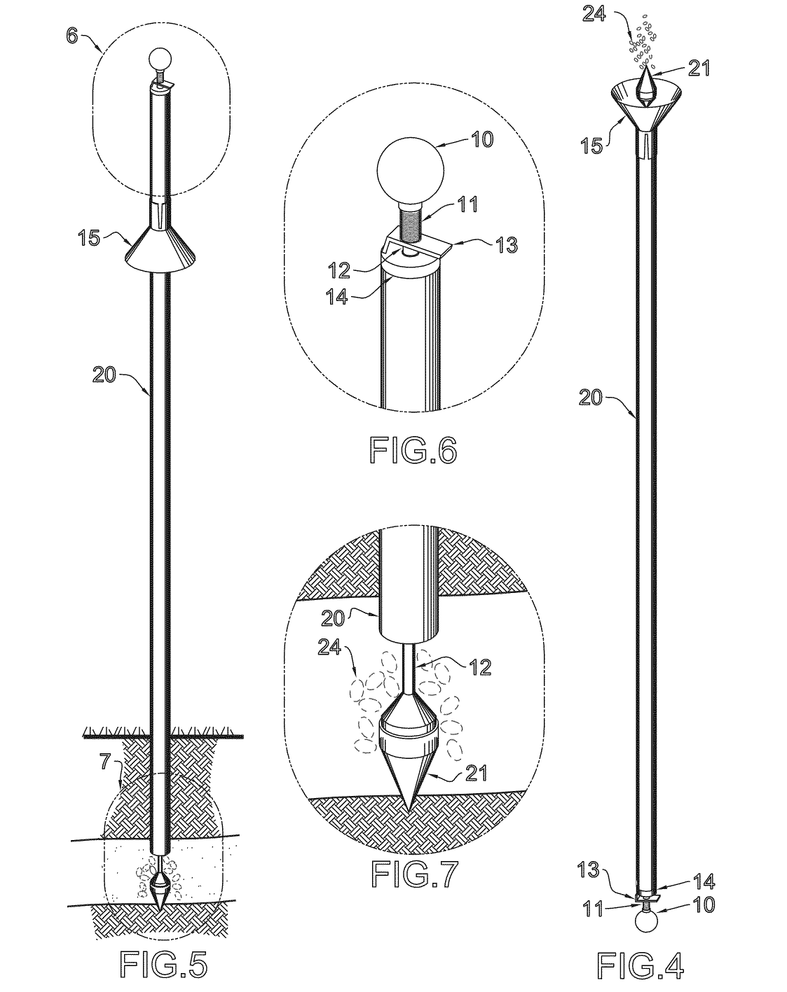

Reference is made to FIG. 4, in which there is illustrated the Rodent Poison Dispenser (hereinafter referred to as ‘the tool’) at the poison loading state. To load, hold the tool vertically by the steel tube 20 with one hand, pressing the control knob 10 on a flat surface. Slide up the plastic filling funnel 15 with the other hand to where the filling funnel stem neck 17 is at the end of the steel tube 20. While still holding the tool by the steel tube 20 with one hand and pressing the control knob 10 on a flat surface, press down on the locking tab 13 with the other hand to unlock the movement of the steel rod 12. The steel rod 12, now unlocked, will cause the steel tube 20 to slide down, opening the poison compartment 23. Maintain the hold on the steel tube 20 and let go of the locking tab 13. Fill the poison compartment 23 via the plastic filling funnel 15 with one dose of a granular poison 24. Lift the tool up to allow the compression spring 11 to close the poison compartment 23 and jam the locking tab 13 onto the steel rod 12 to lock its movement. Slide the plastic filling funnel 15 back to its original position. The tool is now loaded and ready to use.

Reference is made to FIG. 5, in which there is illustrated Rodent Poison Dispenser (hereinafter referred to as ‘the tool’) at the poison dispensing state. Poison is dispensed in rodent tunnels found where the ground surface indicates rodent activity. When the ground is dry and hard, use a small diameter steel rod to poke the ground and assist in locating a tunnel. When the ground is moist and pliable, use the tool to locate tunnels. To locate tunnels with the tool, hold it at the upper end by two hands on the steel tube 20 and push the pointed steel tip 21 into the ground until a push results in finding a rodent's tunnel. The tunnel is found when resistance to a push is suddenly lost and regained. Stop pushing then. Now, the steel tip 21 and the poison compartment 23 are within a rodent tunnel. Maintain hold on the steel tube 20 with one hand and place and keep the palm of the other hand on the control knob 10. Lift up the steel tube 20 while simultaneously lifting the locking tab 13 with the fingers of the hand on the control knob 10. The poison compartment 23 is now open and granular poison 24 is released inside the rodent tunnel. Now release the locking tab 13 and push down the steel tube 20 to re-lock the poison compartment 23. Pull out the tool and cover the surface of the hole made.

What is claimed is:

1. A tool to locate burrowing rodents' tunnels and dispense poison therein to control their damage to vegetation and landscaping, the tool comprising: a pointed steel tip that functions as both ground penetrating head and poison compartment cover.

2. The tool in claim 1, further comprising a central steel rod to control the operations of the pointed steel tip.

3. The tool in claim 1, further comprising a plastic filling funnel, gripping and sliding on the outside surface of the body of the tool.
